(19) United States
(12) Patent Application Publication
(10) Pub. No.: US 2003/0015149 A1
(43) Pub. Date: Jan. 23, 2003

(54) Identification tag apparatus

(76) Inventors: Matthew C. Krey, Strasburg, CO (US); Annette Y. Krey, Strasburg, CO (US)

Correspondence Address: TIMOTHY J MARTIN, PC, 9250 W 5TH AVENUE, SUITE 200, LAKEWOOD, CO, 80226, US

(21) Appl. No.: 10/172,379

(22) Filed: Jun. 13, 2002

Related U.S. Application Data
(60) Provisional application No. 60/298,229, filed on Jun. 13, 2001.

(51) Int. Cl. G09F 3/00; G09F 3/18; A62B 35/00

(52) U.S. Cl. 119/858; 40/304; 40/642.02

(57) ABSTRACT

A tag assembly secures to an animal's body and includes a tag body. The tag body may be made of a flexible base panel and a flexible transparent cover panel joined at their perimeters and elongated to be configurable into a closed loop. Alternatively, one or more elongated attachment bands can form the closed loop. Fasteners are used to retain the tag assembly in a closed loop when secured to the animal. The fasteners include mounting holes on the margin of the tag body or on the elongated attachment band(s). These holes selectively mount on retention posts, and retention grommets are then locked on the retention posts. The retention posts may have pointed heads to punch an identification card or a separate punch post and punch grommet may be provided. The invention contemplates a kit including the tag assembly, an identification card and a marking device.

### CROSS-REFERENCE TO RELATED APPLICATIONS

This application claims the benefit of U.S. Provisional Application No. 60/298,229 filed Jun. 13, 2001.

### TECHNICAL FIELD

The present invention generally relates to an identification tag apparatus. More particularly, this invention relates to an identification tag that is secured to a game animal after the game animal has been taken for the hunter to properly identify his/her game animal and to comply with any legal requirements for game identification or tagging.

### BACKGROUND OF INVENTION

In order to hunt game animals in most jurisdictions, a hunter has to receive a license from a local licensing authority or regulatory agency in the jurisdiction in which the hunter is going to hunt. If and when the game animal is taken, the license may form a part of what is to be attached to the taken game animal for compliance with local regulations. In addition, the hunter has an interest in personally having the animal identifiable once the animal is taken to the butcher for processing. Currently there is no standardized identification apparatus in use for securing to a game animal after the animal has been taken by the hunter to provide a convenient and easy method to identify the hunter and to comply with other legal tagging requirements related to hunting of a particular animal species.

In order to attach an identification tag to take an animal, the hunter currently has to use strings, wire ties, or the like to attach the identification tag to a portion of the taken game animal. Due to the nature of the environment were the hunting is taking place, the tag can often become wet or have contact with the ground, mud, water, snow, rocks and the like, all of which can result in the identification tag easily being lost, partially destroyed or at the very least made illegible.

Therefore, there is a need to provide an identification tag assembly that will provide a protective enclosure for the identification tag itself while allowing the tag to be legible. There is a need for an assembly that will preserve the tag in the normally harsh environmental conditions that is it is subjected to, being water, snow, wind, mud, dirt, rocks, and the like. The present invention addresses these issues in order to provide an identification tag apparatus that will protect and preserve the identification card that is secured to the taken game animal until the butcher processes the animal.

### SUMMARY OF THE INVENTION

It is an object of the present invention to provide a new and useful identification tag assembly that will provide a protective enclosure for an identification card and/or licensing information.

Another object of the present invention is to provide an identification tag assembly that will visually display identification information contained therein.

It is a further object of the present invention to provide an identification tag assembly that can withstand normally harsh environmental conditions such as water, mud, dirt, snow, wind, rocks and the like.

Still a further object of the present invention is to provide an identification tag assembly that can be robustly secured to a selected body part of an animal, such as a game animal taken during hunting.

Yet another object of the present invention is to provide an identification kit which contains all generally employed items to sufficiently identify a game animal during hunting.

In order to accomplish these objects, then, a tag assembly is provided that is adapted to receive an identification card and that is adapted to be secured to a selected body part of a game animal. The tag assembly includes a tag body that is formed of the base panel and a transparent cover panel joined together to form an enclosure sized and adapted to receive the identification card which corresponds to information about the game animal. Means for securing this tag body to the selected body part of the game animal is also provided.

In one embodiment, the tag body has a pair of end edges with a length therebetween and a pair of side edges with a width therebetween. The tag body may be a rectangle having a width less than it's length so that it has a longitudinal body axis extending between the end edges. Here, the means for securing the tag body to the animal is one or more flexible attachment bands each having a proximal end portion. Each such attachment band is elongated sufficiently so that it can be configured in a loop with the distal end portion of the band adjacent to the tag body when the loop engages the selected body part of the game animal. Mateable fasteners are then associated with the attachment band and the tag body. These mateable fasteners are operative to secure the attachment band to the tag body to define a closed loop configuration that encircles the selected body part of the game animal. Here, also, each attachment band may be oriented transversely to the longitudinal body axis of the tag body.

In another embodiment of the invention, the tag body itself is elongated sufficiently such that it can be configured in a loop with the first and second end portions overlapped with one another so that the loop formed by the tag body engages the selected body part of the game animal. Here, a first fastener is associated with a first end portion of the tag body and a plurality of second fasteners extend along a first lateral side edge of the tag body. Each such second fastener is selectively operative to secure to the first fastener thereby to fasten the first and second end portions together to define a closed loop configuration of selected variable size.

In any event, the enclosure formed by the base panel and the transparent cover panel has a mouth through which the identification card may be inserted. This mouth may be formed by an elongated slot located proximately to one end edge of the tag body. It is desirable that a closure be associated with the mouth for selectively opening and closing the mouth. The closure may be defined by mateable rib and channel profile structures on confronting edges of the slot.

Each such attachment band is generally elongated an rectangular in configuration. The second fasteners on each attachment band may be a plurality of spaced apart holes that may be selectively engaged with a first fastener so that the closed loop configuration created by the attachment band may be varied in size.

The first fasteners typically may include a retention post and a retention grommet associated with the tag body. A mounting hole on the attachment band or along the lateral side edge of the tag body may then be inserted over the retention post and the retention grommet placed thereon. To this end, the retention post and the retention grommet can include interlocking structure that is operative to resist removable of the mounting hole from the mounted state by virtue of the fact that the retention grommet becomes locked onto the retention post. Moreover, the retention post, if desired, can include a pointed upper portion configured to form a piercing head. This facilitates marking of punch-through identification tag or licenses employed by governmental regulatory agencies. Alternatively, a punch post may be provided on the tag body and a separate punching grommet provided with this punching grommet may be slidably and releaseably engagable with the punch post.

While the retention post and/or the retention grommet may be mounted on the tag body, it is desirable that one or both or the retention post and retention grommets be disposed on a tab element that is secured to the tag body. Here, the tab element may either be detachable from the tag body to permit engagement of the retention post and the retention grommet or, alternatively, the tab element may be hinged with respect to the tag body to prevent engagement of the retention post and the retention grommet. For both the retention element and the retention grommet are disposed on the tab element and the tab element is secured to the tag body, the tab element is foldable, preferably about hinge, so that the retention grommet may be engaged on the retention post.

In the embodiment wherein the tag body is looped to secure to a selected body part of the game animal, the tag body may be generally rectangular in structure and have a pair of first fasteners associated with the first end portion of the tag body and a plurality of second fasteners extending both along the first and second lateral side edges of the tag body. The second fasteners are again mounting holes with the first fasteners being retention post and retention grommet assemblies, as noted above.

Finally, the present invention is also directed to an identification kit for use by a hunter and tagging a game animal. This identification kit includes an identification card having data entry areas correlated to information about the hunter and/or the license of the hunter. The kit also includes an identification tag assembly that includes a tag body and means for securing the tag body to a selected body part of the game animal. This identification tag assembly could take any of the structures described above. The kit also includes a marking device of a type adapted for entry of the information about the hunter and/or the taken game animal on the identification card.

The identification kit may be contained within a package having an interior that receives the identification card the identification tag assembly and the marking device. Alternatively, the identification kit may be packaged such that the identification card and the marking device are received in the enclosure of the identification tag assembly.

These and other objects of the present invention will become more readily appreciated and understood from a consideration of the following detailed description of the exemplary embodiments of the present invention when taken together with the accompanying drawings, in which:

### BRIEF DESCRIPTION OF DRAWINGS

FIGS. 1(a), 1(b) and 1(c) are perspective views showing alternative attachment of two different embodiments of the present invention, for example, to a leg of a game animal;

FIGS. 2(a) and 2(b) are top plan views showing representative examples of identification tags typically issued by regulatory authorities;

FIG. 3 is a top view in elevation showing a first exemplary embodiment of the present invention in the form of a single band right angle tag assembly;

FIG. 4 is a cross sectional view of the tag body of the tag assembly shown in FIG. 3;

FIG. 5 is a top plan view showing a second embodiment of the present invention in the form of a two-band right angle tag assembly;

FIG. 6 is a top plan view showing a third exemplary embodiment of the present invention in the form of a single band tag assembly with a retention grommet body extension in the form of a detachable tab;

FIG. 7 is a top plan view showing a fourth exemplary embodiment of the present invention showing a single band tag assembly with a retention grommet on a hinged tab;

FIG. 8 is a top plan view showing a fifth embodiment of the present invention showing a pair of retention posts on the tag body and a pair of retention grommets respectively on hinged tabs;

FIG. 9 is a top plan view of a sixth exemplary embodiment of the present invention showing alternative punch posts;

FIG. 10 is a top plan view of a seventh exemplary embodiment of the present invention showing a three band right angle tag assembly;

FIGS. 11(a)-11(c) are end views in partial cross section showing the interaction of the retention grommet with the retention post (with the punch feature) according to any of the foregoing embodiments;

FIG. 12 is an end view in partial cross section showing the operation of the retention post in the punching procedure along with releasable grommet therefor;

FIG. 13(a) and 13(b) show end views in partial cross section showing an alternate embodiment to the retention post and retention grommets of the present invention;

FIG. 14 shows the nested flat pattern layout for manufacturing multiple identification tags being the single band with the end band retention grommet extension;

FIG. 15 shows the nested flat pattern layout for manufacturing multiple identification tags being the single band with a short side retention grommet tab and an opposing medium side grommet tab;

FIG. 16 shows the nested flat pattern layout for manufacturing multiple identification tags being the single band with two opposing short side grommet tabs;

FIG. 17 shows the nested flat pattern layout for manufacturing multiple identification tags being the single band with the long side grommet tab;

FIG. 18 shows the nested flat pattern layout for manufacturing multiple identification tags being the single band right angle identification tag;

FIG. 19 shows the nested flat pattern layout for manufacturing multiple identification tags being the double band right angle identification tag;

FIG. 20 shows the nested flat pattern layout for manufacturing multiple identification tags being the triple band right angle identification tag; and

FIG. 21 shows the kit assembly for the identification tag, the identification card, the marking device, and a package to contain the kit.

### DETAILED DESCRIPTION OF THE EXEMPLARY EMBODIMENTS

The present invention broadly concerns identification tag assemblies of the type that may be secured to a game animal after the game animal has been taken by a hunter. Such an identification tags enable the hunter to properly identify his/her game animal and otherwise comply with applicable legal requirements for taken game. Thus, the identification tag is adapted to be secured to a selected body part of the game animal and receives an identification card and/or a tag or license issued by regulatory authority.

Broadly, the tag assembly of the present invention includes a tag body formed, for example only, by a flexible base panel and a flexible cover panel that are joined together to form an enclosure that receives the identification card and/or other information. Means is provided to secure this tag body to the selected body part of the game animal. Preferably, the cover panel of the tag body is transparent so as to allow the display of information pertaining to the hunter and the animal.

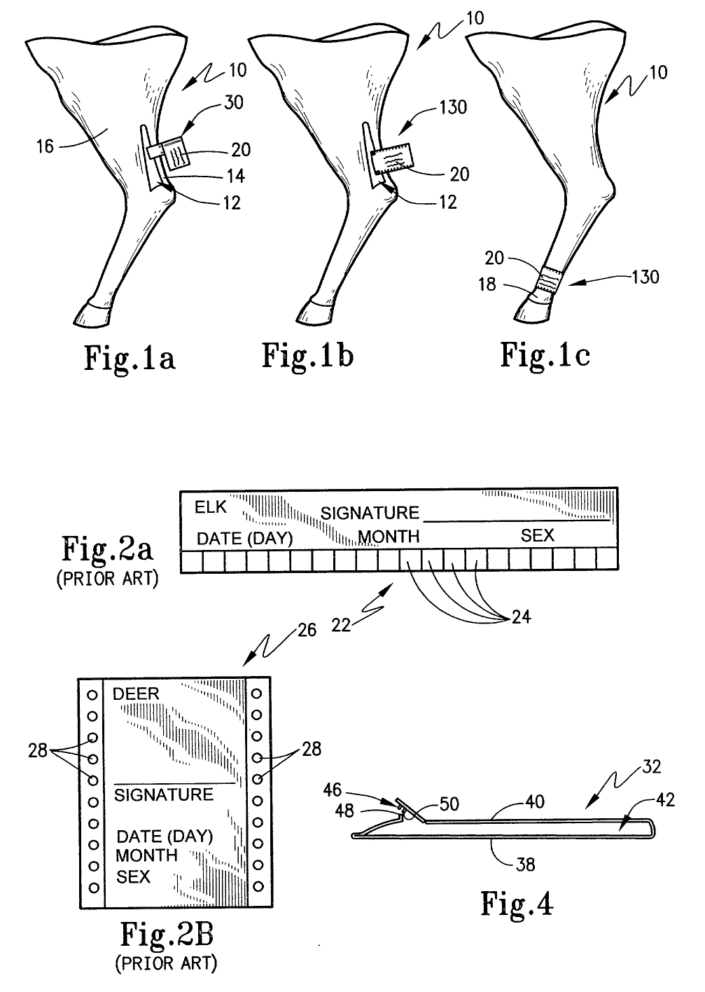

With reference, then, to FIGS. 1(a)-1(c), a representative body part of a game animal, namely, a hind leg 10, is depicted. In FIG. 1(a), a first exemplary embodiment of the present invention in the form of tag assembly 30 that is attached to an upper portion of leg 10. Here, the skin of leg 10 has been cut so that an opening 12 exists between a tendon 14 and the main part of 16 of leg 10. As will be appreciated more thoroughly from the discussion below, tag 30 forms a closed loop configuration that is essentially locked into this opening. Similarly, FIG. 1(b) shows a third exemplary embodiment of the present invention, in the form of tag assembly 130 forming a closed loop configuration that locks into opening 12. In FIG. 1 (c), an alternative mounting of tag assembly 130 is shown wherein it is wrapped around and locked in a closed configuration about ankle 18 of leg 10. As is shown in these figures, information 20 may be viewed through the tag assembly either by the hunter or by a game warden or other representative authority.

As is known, many government regulatory authorities or agencies issue game tag identification cards, permits and/or licenses. Representative examples are shown in FIGS. 2(a) and FIG. 2(b). In FIG. 2(a), an identification card 22 is in the form of a sheeted material on which is printed information such as the type and sex of the animal, the date (day) and the month the animal was taken as well as a signature line for the hunter. Also, along one lateral edge thereof are boxes 24 representing punch out regions corresponding to the date the animal was taken or other information. The hunter is to punch through this region to provide a permanent record of information regarding the taken animal. Similarly, in FIG. 2(b), identification card 26 also provides information about the animal, its sex, the date it was taken as well as a signature line for the hunter along with punch out circles 28 along each lateral edge thereof. According to the present invention the hunter may place an identification card, such as card 22 or 26, inside of the tag assembly either alone or along with other identification cards so that the information 20 as necessary for various state laws can be displayed through the tag assembly.

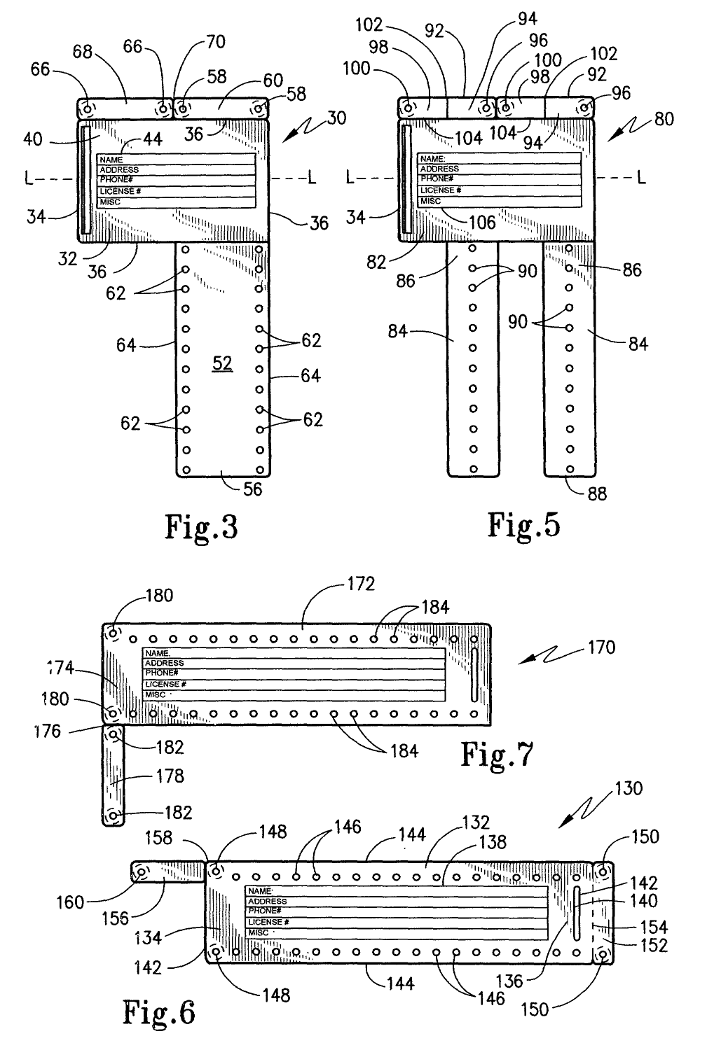

With reference, then, to FIG. 3, the first exemplary embodiment of the tag assembly is shown. Here, tag assembly 30 includes a tag body 32 that is slightly elongated in a rectangular format having a pair of end edges 34 that are spaced apart a length along longitudinal axis “L”. Tag body 32 also has a pair of side edges 36 that define a width for tag body 32 therebetween. With reference to FIG. 4, it may be seen that tag body 32 includes a base panel 38 and a transparent cover panel 40 that form an enclosure 42 therebetween. Panels 38 and 40 are, for example, formed of flexible plastic sheets joined about their common perimeter.

Identification card 44 is received within enclosure 42 and can be an identification card such as licenses or game tags 22, 26 or some other identification card, all as is known in the art. Enclosure 42 has a mouth 46 formed by an elongated slot located proximately to one of end edges 34 so that identification card 44 may be inserted into and removed from enclosure 42. Slot 46 may be releaseably sealed by means of a closure in the form of a rib profile 48 and a confronting channel profile 50 such as known to exist on, for example, flexible sandwich storage bags sold under the trademark Ziploc, a trademark registered to Dow Chemical Company of Midland, Mich. It should be understood other closures for mouth 40 are within the scope of this invention wherein those closures are of a type known to seal two flexible panels, one to the other. Here, though, rib profile 48 will releaseably engage channel profile 50 in a substantially sealed relationship, although it should be understood that it is not required according to the present invention that a seal be maintained in order to fall within the scope of this invention.

Returning again to FIG. 3, it may be seen that tag assembly 30 has at least one flexible attachment band 52 that is elongated sufficiently so that it can be configured in a loop (see FIGS. 1(a)-1(c)). To this end, attachment end 52 has a proximal end portion 54 that is secured to tag body 32 and a free distal end portion 56. When configured in a loop, distal end portion 56 can be curled so as to be adjacent to tag body 32 with the loop engaging the selected body part of the game animal. Preferably, attachment band 52 is formed as an integral one piece construction with base panel 38 and may or may not include a transparent cover panel as an integral extension of cover panel 40, as desired.

In any event, in order to secure distal end portion 56 of attachment band 52 to tag body 32 to define the closed loop configuration, mateable fasteners are associated with the attachment band 52 and the tag body 32. In the embodiment shown in FIG. 3, these fasteners include retention posts, such as retention posts 58, that are formed on a tab 60 formed as an integral one piece construction with base panel 38. Flexible attachment band 52, which is in the form of a generally elongated rectangle that is oriented transversely to the longitudinal axis “L” of tag body 32, has a plurality of mounting holes 62 formed along each lateral side edge 64 thereof. Mounting holes 62 are equidistantly spaced apart from one another and provide an adjustment capability so that the dimension of the closed loop configuration created by attachment bad 52 may be varied to accommodate the selected body part of the taken game animal. Thus, it should be understood that attachment band 52 may be looped around and a selected pair of holes 62 positioned over retention posts 58.

In order to secure attachment band 52 in the closed loop configuration, a pair of retention grommets 66 may be positioned and locked onto retention post 56. To this end, retention grommets 66 are located on a tab 68 that is hinged, at 70, to tab 60 the structure of this fasteners are described more thoroughly below.

With reference to FIG. 5, a second exemplary embodiment of the present invention is shown. Here, tag assembly 80 includes a tag body 82 of a construction substantially identical to that of tag body 32. Here, however, a plurality of flexible attachment bands 84 extends transversely to longitudinal body axis “L” and are in the form of elongated triangular pieces that are in generally parallel, spaced apart relationship to one another. Each attachment band 84 includes a proximal end portion 86 that is secured or may be an integral extension of the base panel of tag body 82 and a free distal end portion 88.

Each attachment band 84 is provided with a single row of spaced apart mounting holes 90 that are adapted to engage retention posts of a type similar to retention posts 58. With reference to FIG. 5, however, it may be seen that a pair of tabs 92 are provided on a side end edge opposite attachment bands 84 with each tab 92 having a first section 94 that carries a retention post 96 and a second section 98 that carries a grommet 100. First sections 94 are joined to tag body 82 while second sections 98 are separated by slits 104 therefrom so that first and second sections 94 and 98 may be folded with respect to one another about hinge line 102. Here, again, identification card, such as card 106 is in the interior of the enclosure formed by tag body 82.

Turning now to FIGS. 6, 7, 8 and 9, four alternative exemplary embodiments of the present invention are disclosed. In each of these embodiments, the flexible attachment bands are eliminated in favor of an elongated tag body that is itself sufficiently elongated so that it may be configured in a loop. However, the overall construction of these tag bodies, insofar as it relates to the presence of a flexible base panel, a flexible transparent cover panel joined to the base panel to form an enclosure having a mouth and a closure therefore, is as described with respect to tag bodies 32 and 82 so that a description of this structure is not again repeated. Rather, the departures from the structures shown in FIGS. 6-9 are discussed to point out variations that may be used with respect to the tag assemblies of the present invention. Indeed, in this regard, various embodiments of the present invention show different features, and it should be understood that any permutations of these features may be employed to create a tag assembly without departing from the scope of this invention.

Turning, then, to FIG. 6, it may be seen that tag assembly 130 is in the form of a tag body 132 that is in the form of an elongated rectangular configuration having a first end portion 134 and a second end portion 136 that are opposite to one another. Here, again, tag body 132 includes a flexible base panel and a flexible transparent cover panel joined to the base panel to form an enclosure sized and adapted to receive an identification card, such as identification card 138. Identification card 138 is insertable through mouth 140 that is adjacent to the second end portion 136 of tag body 132. To this end, tag body 132 has a pair of end edges 142 defining a length for tag body 132 and a pair of side edges 144 defining a width therefore. A plurality of mounting holes 146 extend along the margins adjacent to each lateral side edge 144.

Tag body 142 may be curled into a loop configuration and locked into positioned around a selected body part of the game animal, as is depicted in FIGS. 1(b) and 1 (c). To this end, a pair of spaced apart retention posts 148 are disposed at first end portion 134 and are located in the margins collinearly with mounting holes 146. When tag body 132 is looped into the closed loop configuration, a selected pair of mounting holes 144 can be engaged on retention posts 148. A pair of retention grommets 150 are disposed on tab 152 that is detachable from side edge 142 along perforation line 154. Retention grommets 150 are spaced apart a distance the same as retention posts 148 so that retention grommets 150, and thus tab 152, may be locked onto retention post 148 with the second end portion of tag body 132 locked therebetween when the first and second end portions of tag body 132 are overlapped with one another.

A second tab 156 is hinged to tag body 132 by hinge 158 with tab 156 sporting a punching grommet 160 that does not lockably engage retention post 148 but rather is slideably and releaseably engagable therewith. Tab 156 is flexible so that punching grommet 160 may be moved onto and off of its associated retention post 148 for the purpose of punching a license or game tag as described more thoroughly below with respect to FIG. 12.

A fourth exemplary embodiment of the present invention is shown in FIG. 7. Here, tag assembly 170 has a tag body 172 that is constructed substantially identically as tag body 132. Accordingly, a description of this structure is not repeated. Here, tabs 152 and 156 have been eliminated. In place of tab 152, a tab 178 is hinged to first end portion 174 along the short side of tab 178 at hinge 176. Tab 178 carries a pair of retention grommets 182 that are adapted to mate with retention posts 180 disposed on first end portion 174. Thus, when tag body 172 is curled into the closed configuration so that its mounting holes 184 engage posts 180, tab 178 may be folded onto first end portion 174 such that retention grommets 182 lock onto retention posts 180.

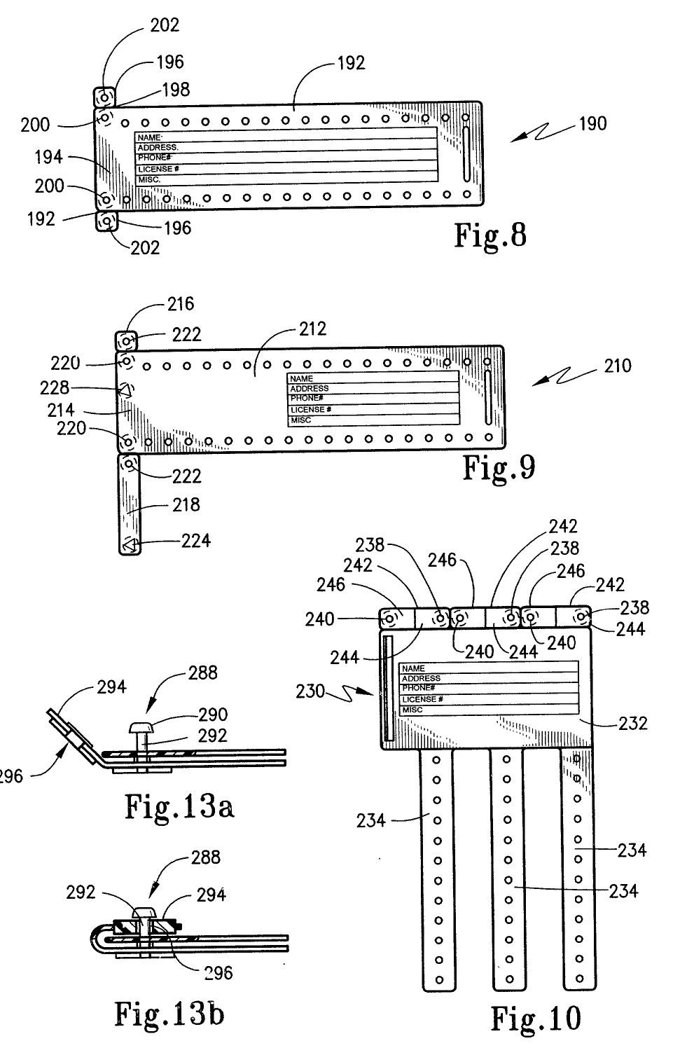

In FIG. 8, a fifth exemplary embodiment of the tag assembly is shown in the form of tag assembly 190 which again has a tag body similar to tag body's 132 and 172. Here, though, tag body 192 has a pair of retention posts 200 on first end portion 194. Small tabs 196 are provided on opposite side edges of tag body 192 adjacent to first end portion 194. Tabs 196 are hinged at 198 to tag body 192. Tabs 196 each carry a respective retention grommet 202 that are respectively positioned to lockably engage a respective retention post 200 when tabs 196 are folded onto first end portion 194 of tag body 192.

FIG. 9 shows a sixth exemplary embodiment of the present invention in the form of tag assembly 210 that is substantially identical to tag assembly 190 shown in FIG. 8. Here, though, tag body 212 has a first end portion 214 that carries a pair of retention posts 220. A punch post 228, however, is also disposed on first end portion 214 in order to punch a license or other identification tag. Retention grommets 222 are respectively disposed on tabs 216 and 218 that are hinged to first end portion 214. Here, however, tab 218 is elongated and includes a punching grommet 224.

A seventh exemplary embodiment of the present invention is shown in FIG. 10. Here, tag assembly 230 includes a tag body 232 from which three flexible attachment bands 234 extend in parallel spaced apart relation from one another. The structure of tag assembly 230 shown in FIG. 10 is similar to that described with respect to tag assembly 80 with the exception that three attachment bands are provided and, correspondingly, three tabs 242 are provided. Each tab 242 includes a first section 244 that is connected to tag body 232 and a second section 246 that is hinged to first section 244 and is separated from tag body 232. Sections 244 carry retention posts 238 while sections 246 carry retention grommets 240 which operate in the manner described above.

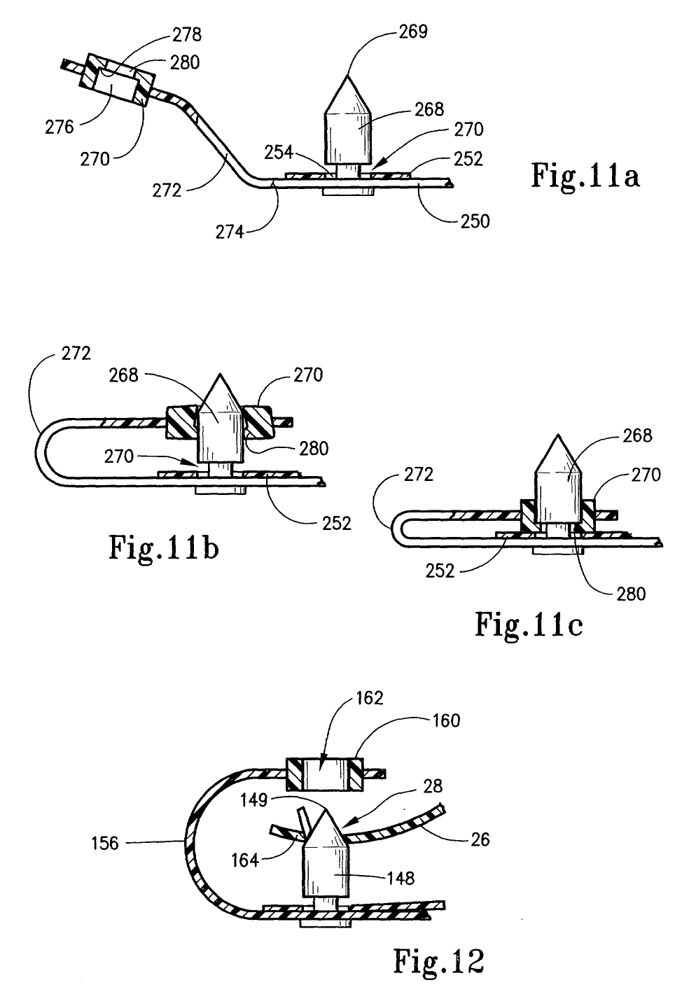

Turning now to FIGS. 11(a)-11(c), it may be seen how a representative retention grommet engages a representative retention post. In these figures, it may be seen that a retention post 268 has an upper pointed end in the form of piercing point 269 that has the capability of punching out holes in the identification card, such as identification cards 22 and 26. In these figures, it may be seen that a representative attachment band 252 has been looped so that its mounting hole 254 is received on retention post 268. Retention post 268 has an annular channel 270 adjacent the base thereof which is secured to tag body 250. Accordingly, post 268 has a waisted portion adjacent to tag body 250.

Retention grommet 270 is supported on tab 272 that is hinged at 274 to tag body 250 so that it may mount onto retention post 268. To this end, retention grommet 270 has an axial opening 276 sized for close fitted mated engagement with post 268. An annular shoulder 278 is formed on retention grommet 270 so that it has an inwardly projecting annular rib 280. As is shown in reference to FIGS. 11(b) and 11(c), as retention grommet 270 is matably mounted onto retention post 268, rib 280 becomes interlocked into annular channel 270 so as to prevent removal of grommet 270 from retention post 268 when fully engaged thereon. This locks attachment band 252 in position in the mounted state.

With reference now to FIG. 12, the use of a punching grommet 160 with a retention post 148, such as noted with respect to tag assembly 130 shown in FIG. 6, above. Here, a representative hole 28 of identification card 26 is being punched by piercing pointed end 149 of post 148. To facilitate this, punching grommet 160 has an axial opening 162 that is sized to be slightly larger than the diameter of cylindrical retention post 148. Due to the flexibility of tab 156, punching grommet 160 can be placed onto retention post 148 to force the margin portion 164 of tag 26 onto post 148 with post 148 passing through opening 162. This punches hole 28. However, due to the larger diameter of opening 162 and the lack of the retaining rib, such as rib 280 described above, punching grommet 160 may be removed from post 148 and the resulting punched identification tag 26 withdrawn from post 148. After the punching operation, of course, the identification card 26 may be placed in the enclosure of the tag body. It should be understood that the structure corresponding to punching grommet 160 may be provided on any of the embodiments described above and that other shaped punch ports or structures may be employed.

Turning next to FIGS. 13(a) and 13(b), an alternative embodiment of the retention post is shown. Here, a representative retention post 288 has an enlarged dome head 290 that is supported by a narrower diameter shaft 292. Dome head 290 has an arcuate profile and is adapted to receive a retention grommet 294 thereon. Grommet 294 has an opening 296 that is larger than the diameter of shaft 292 but slightly smaller than that 290. Retention grommet 294 may thus be pressed fit onto retention post 288 due to the curvature of dome head 290 but becomes relatively locked into position, as is shown in FIG. 13(b) since the height of shaft 292 is greater than the thickness of grommet 294.

It should be understood by the ordinarily skilled artisan that a variety of different types of retention posts and retention grommets could be employed without departing from the scope of this invention. Moreover, other retention structures could be used to retain the attachment bands on a respective mounting post when the closed loop configuration is desired for the respective tag assembly.

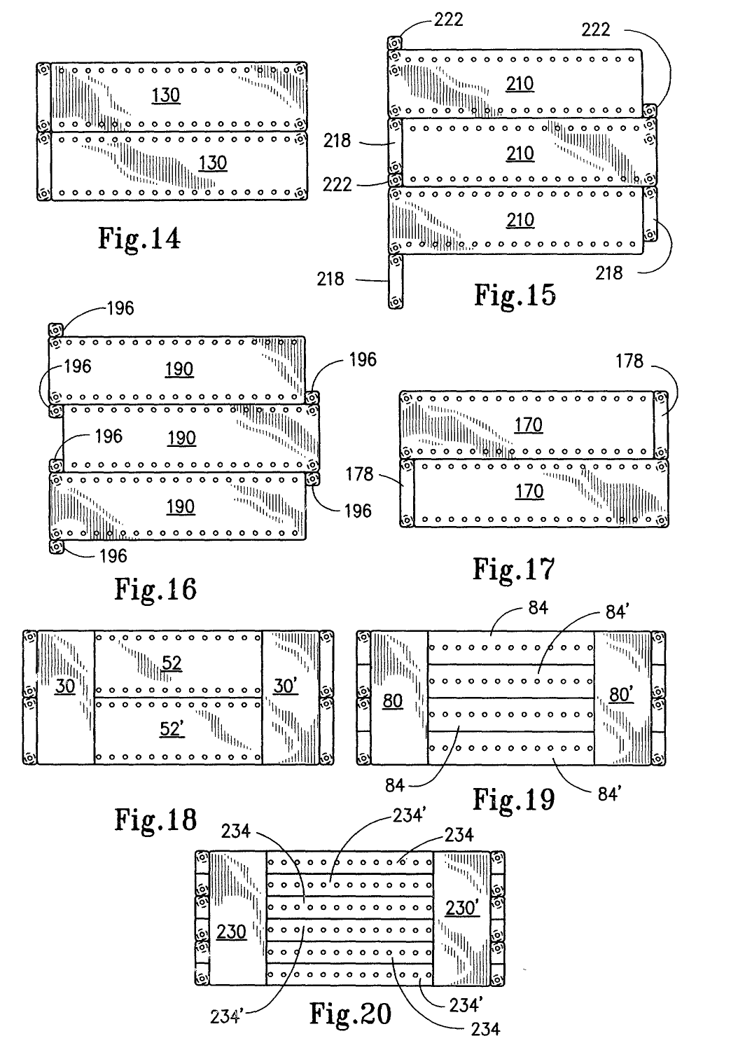

Turning to FIGS. 14-20, various nested multiple pattern layouts for manufacturing various embodiments of the tag assemblies according to the present invention are shown. These nested pattern layouts are designed to minimize the waste materials. Thus, for example, in FIG. 14, a multiple pattern layout for tag assembly 130 here, without the use of tab 156 and punching grommet 160, is shown. Here, two tag assemblies 130 are depicted with the two tag assemblies being organized in a side by side relationship because of their symmetric configuration. In FIG. 15, though, a pattern layout for three tag assemblies 210, such as shown in FIG. 9, are illustrated. Here, the three tag assemblies are alternated end to end to accommodate the non symmetrical relationship of tabs 218 and 222, and their respective retention grommets.

In FIG. 16, three tag assemblies 190 are shown. Here, again, the tag assemblies are alternated end-to-end to accommodate the non-symmetrical relationship of tabs 196. A pattern layout for two tag assemblies 170 is shown in FIG. 17, with these tag assemblies, corresponding to the tag assemblies of FIG. 7. Here, again, the ends of the tag assemblies are alternated to accommodate the non-symmetrical relationship of the tabs 178.

FIGS. 18, 19 and 20 show pattern layouts for the tag assemblies embodiments shown, respectively, in FIGS. 3, 5 and 10. In FIG. 18, two tag assemblies 30 and 30′ are shown with their respective attachment bands 52 and 52′ alternated for manufacturing purposes. Here, tag assemblies 30, 30′ are alternated end to end due to the non-symmetrical orientation from the attachment band and the tag bodies. Likewise, in FIG. 19, two tag assemblies 80, 80′ are shown with their respective bands 84, 84′ interleaved with one another to accommodate for the non-symmetrical relationship. In FIG. 20, two tag assemblies 230 and 230′ show their respective attachment bands 234 and 234′ alternating for manufacturing economies.

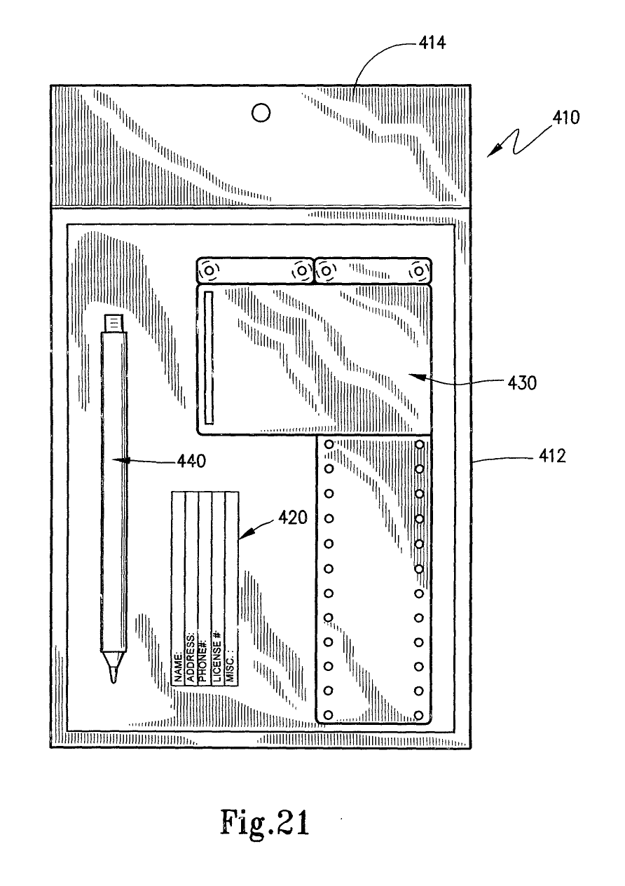

As noted above, the present invention is also directed to a identification kit to be used by a hunter in tagging a game animal. It is desired that this identification kit be self contained so as to provide the hunter with all necessary components to effectively and properly mark the taken animal. In FIG. 21 identification kit 410 is shown to include a package 412 that may have a hang tag 414. Package 412 has an interior, as is commonly known, and it receives the three components in the form of an identification card 420 a tag assembly 430 and a marking device 440. It should be understood that identification card 420 may be a general information card provided to the hunter or, alternative, may be a license from a regulatory agency with the kit sold as part of the license. Tag assembly 430 may be any type of tag assembly as described above with tag assembly 430 illustrated in FIG. 21 being similar to tag assembly 30 shown in FIG. 3. Marking device 440 is in the form pen or pencil that may be used to enter information into the data entry areas 421 on identification card 420.

While the kit shown in FIG. 21 is in an independent package, it should be appreciated that an alternative packaging is possible. Here, identification card 420 and a suitably sized marking device 440 are placed and enclosed in the enclosure in the tag body of the respective tag assembly 430. This eliminates the need for independent package 412.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

We claim:

1. A tag assembly adapted to receive an identification card and to be secured to a selected body part of a game animal, comprising:
(A) a tag body including a base panel and transparent cover panel joined together to form an enclosure sized and adapted to receive an identification card corresponding to information about the game animal, the enclosure having a mouth through which the identification card may by inserted, and including a closure associated with the mouth for selectively opening and closing the mouth;
(B) at least one flexible attachment band including a proximal end portion secured to said tag body and a free end portion, said attachment band elongated sufficiently such that it can be configured in a loop with said distal end portion adjacent to said tag body with the loop engaging the selected body part of the game animal; and
(C) matable fasteners associated with said attachment band and said tag body and operative to secure said attachment band to said tag body to define a closed loop configuration.

2. A tag assembly according to claim 1 wherein said tag body has a pair of end edges with a length therebetween and a pair of side edges with a width therebetween with the width being less than the length, said tag body having a longitudinal body axis extending between the end edges.

3. A tag assembly according to claim 2 wherein the longitudinal axis is oriented transversely to said attachment band.

4. A tag assembly according to claim 2 wherein the mouth is formed by an elongated slot located proximately to one of said end edges.

5. A tag assembly according to claim 4 wherein said closure is defined by matable rib and channel profile structures on confronting edges of the slot.

6. A tag assembly according to claim 1 including a plurality of flexible bands each including a proximal end portion secured to said tag body and a free end portion, said bands oriented in substantially parallel relation to one another.

7. A tag assembly according to claim 1 wherein said attachment band is generally rectangular in configuration.

8. A tag assembly according to claim 1 wherein said fasteners include a retention post and a retention grommet associated with said tag body and at least one mounting hole associated with said band, said mounting hole adapted to matably engage said post in a mounted state to define the closed loop configuration and said retention grommet adapted to engage said retention post in and engaged state and thereby retain the mounting hole in the mounted state.

9. A tag assembly according to claim 8 wherein said retention post and said retention grommet include interlocking structure operative to resist removal of the mounting hole from the mounted state.

10. A tag assembly according to claim 8 wherein said retention post has a upper portion configured to form a piercing head.

11. A tag assembly according to claim 8 wherein one of said retention post and said retention grommet is disposed on said tab body and another of said retention post and said retention grommet is disposed on a tab element that is secured to said tag body.

12. A tag assembly according to claim 11 wherein said tab element is detachable from said tag body to permit engagement of said retention post and said retention grommet.

13. A tag assembly according to claim 11 wherein said tab element is hinged with respect to said tag body to permit engagement of said retention post and said retention grommet.

14. A tag assembly according to claim 8 wherein said retention post and said retention grommet are each disposed on a tab element that is secured to said tag body, said tab element being foldable whereby said retention grommet may be engaged on said retention post.

15. A tag assembly according to claim 1 including a punch post and a punching grommet, said punching grommet being slidably and releasably engageable with said punch post.

16. A tag assembly adapted to receive an identification card and to be secured to a selected body part of a game animal, comprising:
(A) a tag body having a length extending along a longitudinal body axis and a width that is less than the length thereof, said tag body including a base panel and transparent cover panel joined together to form an enclosure sized and adapted to receive an identification card corresponding to information about the game animal, the enclosure having a mouth through which the identification card may by inserted;
(B) at least one flexible attachment band including a proximal end portion secured to said tag body and a free end portion, said attachment band elongated in a direction that is transverse to the longitudinal body axis sufficiently such that it can be configured in a loop with said distal end portion adjacent to said tag body with the loop engaging the selected body part of the game animal; and
(C) matable fasteners associated with said attachment band and said tag body and operative to secure said attachment band to said tag body to define a closed loop configuration.

17. A tag assembly according to claim 16 wherein said fasteners include a retention post and a retention grommet associated with said tag body and at least one mounting hole associated with said band, said mounting hole adapted to matably engage said post in a mounted state to define the closed loop configuration and said retention grommet adapted to engage said retention post in and engaged state and thereby retain the mounting hole in the mounted state.

18. A tag assembly according to claim 17 wherein said retention post and said retention grommet include interlocking structure operative to resist removal of the mounting hole from the mounted state.

19. A tag assembly according to claim 17 wherein said retention post has a upper portion configured to form a piercing head.

20. A tag assembly according to claim 17 wherein one of said retention post and said retention grommet is disposed on said tab body and another of said retention post and said retention grommet is disposed on a tab element that is secured to said tag body.

21. A tag assembly according to claim 20 wherein said tab element is detachable from said tag body to permit engagement of said retention post and said retention grommet.

22. A tag assembly according to claim 20 wherein said tab element is hinged with respect to said tag body to permit engagement of said retention post and said retention grommet.

23. A tag assembly according to claim 17 wherein said retention post and said retention grommet are each disposed on a tab element that is secured to said tag body, said tab element being foldable whereby said retention grommet may be engaged on said retention post.

24. A tag assembly according to claim 16 including a punch post and a punching grommet, said punching grommet being slidably and releasably engageable with said punch post.

25. A tag assembly adapted to receive an identification card and to be secured to a selected body part of a game animal, comprising:
(A) a tag body having opposite first and second end portions and including a flexible base panel and flexible transparent cover panel joined to said base panel to form an enclosure sized and adapted to receive an identification card corresponding to information about the game animal with the enclosure having a mouth through which the identification card may by inserted, said tag body elongated sufficiently such that it can be configured in a loop with said first and second end portions overlapped with one another with the loop engaging the selected body part of the game animal; and
(B) a first fastener associated with the first end portion of said tag body and a plurality of second fasteners extending along a first lateral side edge of said tag body, each said second fastener operative to selectively secure to said first fastener thereby to fasten the first and second end portions together to define a closed loop configuration a selected variable size.

26. A tag assembly according to claim 25 wherein said tag body is generally rectangular in configuration with a pair of end edges with a length therebetween and a pair of side edges with a width therebetween with the width being less than the length and wherein the mouth is formed by an elongated slot located proximately to one of said end edges.

27. A tag assembly according to claim 26 including matable rib and channel profile structures on confronting edges of the slot to define a closure for the mouth.

28. A tag assembly according to claim 25 including a pair of first fasteners associated with the first end portion of said tag body and a plurality of second fasteners extend along a second lateral side edge of said tag body.

29. A tag assembly according to claim 25 wherein said first fasteners include a retention post and a retention grommet and wherein said second fasteners are mounting holes, each said mounting hole adapted to matably engage said retention post in a mounted state to define the closed loop configuration and said retention grommet adapted to engage said retention post in and engaged state and thereby retain the mounting hole in the mounted state.

30. A tag assembly according to claim 29 wherein said retention post has a upper portion configured to form a piercing head.

31. A tag assembly according to claim 29 wherein one of said retention post and said retention grommet is disposed on said tab body and another of said retention post and said retention grommet is disposed on a tab element that is secured to said tag body.

32. A tag assembly according to claim 31 wherein said tab element is detachable from said tag body to permit engagement of said retention post and said retention grommet.

33. A tag assembly according to claim 31 wherein said tab element is hinged with respect to said tag body to permit engagement of said retention post and said retention grommet.

34. A tag assembly according to claim 29 wherein said retention post and said retention grommet are each disposed on a tab element that is secured to said tag body, said tab element being foldable whereby said retention grommet may be engaged on said retention post.

35. A tag assembly according to claim 25 including a closure associated with the mouth.

36. A tag assembly adapted to receive an identification card and to be secured to a selected body part of a game animal, comprising:
(A) a generally rectangular tag body having a pair of end edges with a length therebetween and a pair of side edges with a width therebetween with the width being less than the length, said tag body having a longitudinal body axis extending between the end edges, said tag body including
(1) a base panel and
(2) transparent cover panel joined together to form an enclosure sized and adapted to receive an identification card corresponding to information about the game animal, the enclosure having a mouth through which the identification card may by inserted wherein said tag body;
(B) at least one flexible attachment band including
(1) a proximal end portion secured to said tag body and
(2) a free end portion and
(3) a plurality of mounting holes disposed thereon, said attachment band elongated sufficiently such that it can be configured in a loop with said distal end portion adjacent to said tag body with the loop engaging the selected body part of the game animal; and
(C) a retention post and a retention grommet associated with said tag body, said mounting holes adapted to matably engage said post in a mounted state to define the closed loop configuration and said retention grommet adapted to engage said retention post in and engaged state and thereby retain the mounting hole in the mounted state.

37. A tag assembly according to claim 36 wherein said retention post and said retention grommet include interlocking structure operative to resist removal of the mounting hole from the mounted state.

38. A tag assembly according to claim 36 wherein one of said retention post and said retention grommet is disposed on said tab body and another of said retention post and said retention grommet is disposed on a tab element that is secured to said tag body.

39. A tag assembly according to claim 38 wherein said tab element is detachable from said tag body to permit engagement of said retention post and said retention grommet.

40. A tag assembly according to claim 38 wherein said tab element is hinged with respect to said tag body to permit engagement of said retention post and said retention grommet.

41. A tag assembly according to claim 36 wherein said retention post and said retention grommet are each disposed on a tab element that is secured to said tag body, said tab element being foldable whereby said retention grommet may be engaged on said retention post.

42. A tag assembly according to claim 36 including a plurality of flexible attachment bands, each attachment band including a proximal end portion secured to said tag body, a free end portion and a plurality of mounting holes disposed thereon, each said attachment band elongated sufficiently such that it can be configured in a loop with said distal end portion adjacent to said tag body with the loop engaging the selected body part of the game animal.

43. An identification kit for use by a hunter in tagging a game animal, comprising:
(A) an identification card having data entry areas correlated to information about the hunter;
(B) an identification tag assembly including
(1) a tag body having a base panel and transparent cover panel joined together to form an enclosure sized and adapted to receive said identification card such that the information entered in said data entry areas is visually displayed through said cover panel;
(2) means for securing said tag body to a selected body part of the game animal; and
(C) a marking device of a type adapted for entry of the information about the hunter on said identification card.

44. An identification kit according to claim 43 wherein said identification card and said marking device are packaged in the enclosure.

45. An identification kit according to claim 43 including a package having an interior that receives said identification card, said identification tag assembly and said marking device.

46. An identification kit according to claim 43 wherein means for securing said tag body includes a retention post and a retention grommet associated with said tag body and at least one elongated band extending from said tag body and having a plurality of mount holes adapted to engage said retention post.

47. An identification kit according to claim 43 wherein said tag body has opposite first and second end portions and is elongated sufficiently such that it can be configured in a loop with said first and second end portions overlapped with one another with the loop engaging the selected body part of the game animal and wherein said means for securing said tag body includes a retention post and a retention grommet associated with the first end portion of said tag body and a plurality of mounting holes extending along a lateral side edge of said tag body, said mounting holes operative to selectively secure to said retention post thereby to fasten the first and second end portions together to define a closed loop configuration a selected variable size.
